(19) United States
(12) Patent Application Publication
(10) Pub. No.: US 2007/0294370 A1
(43) Pub. Date: Dec. 20, 2007

(54) Scheduling and information sharing and distribution system and method

(76) Inventors: William F. Fay, Beverly Hills, CA (US); Jody Beth Fay, Beverly Hills, CA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/168,166

(22) Filed: Jun. 28, 2005

Related U.S. Application Data
(60) Provisional application No. 60/583,711, filed on Jun. 29, 2004.

(51) Int. Cl. G06F 15/16

(52) U.S. Cl. 709/219

(57) ABSTRACT

A system and method for coordinating online and offline schedules. The system allows a user to streamline calendar information from various online and offline sources into one distribution channel. The system and method provides an online interface with numerous outlets to other calendar systems, without the need for a license for each additional calendar system. In general, the system is capable of maintaining varying capacity and is scalable. As such, the system is able to manage huge variation and user populations in a small data set. Information can be standardized to be entered into the system only once and subsequently be distributed to various types of programs and platforms.

Priority based on U.S. Provisional Patent Application, Ser. No. 60/583,711, filed on Jun. 29, 2004, and entitled, “Scheduling And Information Sharing And Distribution System And Method” is claimed.

### BACKGROUND

I. Field of the Invention

The present invention relates generally to the field of online and offline scheduling and information distribution and sharing and more particularly to a scheduling, calendar and information distribution system and method.

II. Description of the Related Art

Many software calendar applications and local C++ or Visual Basic programs require the user to enter events into their application and only from a machine with a licensed software package. Furthermore, users and entities having common events often have trouble centralizing and organizing the common event information so that conflicts are identified and minimized. Furthermore, there is no one standardized system for widespread distribution of calendar events over a network from a single source so that a plurality of computers with various operating systems and calendar program software can pick up the events and integrate them into their own platforms.

### SUMMARY

In general, the invention features a system and method for coordinating online and offline schedules. The system provides a widespread distribution of calendar events over a network where a plurality of computers can pick up the events into their own platform and scheduling or calendar application package for full integration of the respective schedule onto the computer. The system allows a user to streamline calendar information from various online and offline sources into one distribution channel. The system and method can provide an online interface with numerous outlets to other calendar systems, without the need for a license for each additional calendar system. Information can be standardized to be entered into the system only once and subsequently be distributed to various types of programs and platforms. Therefore, the system provides an online interface with numerous outlets to other software packages, modules and calendar packages.

In a typical implementation, the system and method can be utilized to manage parent and child schedules and can be further used to manage thousands of school calendars from one central location. The various calendars can be distributed to the faculty of each school and can also be available to parents. The streamlined distribution of information can include homework assignments, sporting events, database and file-based driven websites for classes, distribution for teachers and the like. In a typical implementation, the system and method is a back-end solution for schools.

In general, in one aspect, the invention features a scheduling system, including a central server connected to a network, a plurality of user computers connected to the network, a webpage having a schedule of events stored in a database, a process for allowing events to be added to the database and a process for allowing selected events from the webpage to be downloaded to one or more of the plurality of user computers by a single click.

In another aspect, the invention features a scheduling system, including a central server connected to a network, a plurality of user computers connected to the network, a webpage for displaying and manipulating a schedule of events stored in a database, the webpage being accessible by the central server and the plurality of user computers, a process for adding events to the database from the central server and from the plurality of user computers, a process for choosing a subset of selected events from the webpage to be downloaded to one or more of the plurality of user computers by a single click and a process residing on the central server for processing the events in the database and distributing the events over the network.

In one implementation, the system further includes at least one object that has a unique schedule of information.

In another implementation, the system further includes at least one user object having unique user information.

In another implementation, the system further includes at least one client object having unique client information.

In another implementation, the system further includes session variables that are stored on the central server while the webpage is accessed by one or more of the user computers.

In another implementation, the system further includes objects having associated class libraries.

In yet another implementation, the system further includes a session file, including data related to the class libraries and data related to user objects.

In yet another implementation, the system further includes school objects that are correlated with the user objects.

In another implementation, the school object includes a school identifier and the user object includes a user identifier.

In another implementation, the school identifier and user identifier are used to access and pass data related only to the school and user identifiers.

In another implementation, the user and school objects are correlated by a string that identifies desired data from the school object.

In another aspect, the invention features a method of obtaining calendar information, including accessing an online webpage having an online calendar connected to a database, choosing event categories associated with the webpage and the database, previewing specific events included in each category and downloading the online calendar events to a personal calendar located on a user computer.

In another aspect, the invention features a method of organizing events, including receiving a plurality of related event information from a plurality of sources having a common relation, organizing the event information into event categories in an online database connected to an online calendar, making the database available to the plurality of sources, optionally allowing the plurality of sources to modify and add to the database and allowing the plurality of sources to access and download the event information in a form suitable to the personal preferences of the individual source.

In one implementation, the method further includes a user object and a school object.

In another implementation, the user and school objects are related by identifying a subset of data from the school object into the user object.

In another implementation, the plurality of sources each includes a user object.

In another implementation, the plurality of sources can each access and download the event information in a form suitable to the personal preferences of the individual source and optionally modify and add to the database through the user objects.

One advantage of the invention is that voluminous scheduling information can be compiled into a single distribution channel that many users can access.

Another advantage of the invention is information can be standardized and be made available to various other programs and modules.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates a system level diagram of an embodiment of a scheduling, calendar and information distribution system;

FIG. 2 illustrates an embodiment of a scheduling webpage;

FIG. 3 illustrates an embodiment of a parent request webpage;

FIG. 4 illustrates an embodiment of a school request webpage;

FIG. 5 illustrates an embodiment of a organization request webpage;

FIG. 6 illustrates an embodiment of an online calendar webpage;

FIG. 7 illustrates an embodiment of a category selection webpage; and

FIG. 8 illustrates an embodiment of a calendar preview webpage.

### DETAILED DESCRIPTION

A system and method for coordinating online and offline schedules is described. The embodiments described herein are able to manage huge numbers of variations from a very small database record set. The system allows a user to streamline calendar information from various online and offline sources into one distribution channel. The system and method can provide an online interface with numerous outlets to other calendar systems, without the need for a license for each additional calendar system. Information can be standardized to be entered into the system only once and subsequently be distributed to various types of programs and platforms. Therefore, the system provides an online interface with numerous outlets to other software packages, modules and calendar packages.

In a typical implementation, the system and method can be utilized to manage parent and child schedules and can be further used to manage thousands of school calendars from one central location. The various calendars can be distributed to the faculty of each school and can also be available to parents. The streamlined distribution of information can include homework assignments, database and file-based driven websites for classes, distribution for teachers and the like. In a typical implementation, the system and method is a back-end solution for schools. In general, it is further understood that several other organizations can implement the system. For example, sports leagues can advantageously use the system. In general, the system can be implemented by any organization that disseminates scheduling information to a large number of users and customizes the information and downloads the data into multiple calendar platforms.

In a typical system, a centralized location receives numerous requests to be added to the system. The requests can come from schools, parents, other individuals and organizations and clubs. Typically, the requests come from those users who wish to be added to the main distribution channel through which the scheduling information flows. In this way, each user has input into the schedule of events so that conflicts are minimized or fully eliminated. For example, a school administrator can access the system and submit an online request to be added to the system. The system administrator receives the request and the school, in this instance, is added to the database. In a typical implementation, many languages can be used such as PHP, HTML, C++, Javascript, XML or any other suitable language. In a typical implementation the database is MySQL.

Once the request has been received and processed and the school is entered into the database, the system administrator provides the school administrator a unique username and password. Immediately, the school administrator can add event categories to the online calendar provided in the system. The school administrator can then add specific events to the online calendar.

Similarly, parents can access the system and create an account. Every time the parent logs into the system, the parent can select the categories of events that they want to view. The entire online calendar is then displayed to the parent and they can download the online calendar directly into their personal computer or other device, into a suitable application such as Microsoft Outlook.

In general, the system is an online application that maintains application status through unique session variables for each user. The session variables are stored on a central server while the browser is open.

In a typical embodiment, class libraries are written for each unique object in the system. For example, the class object “Users” contains all the needed properties and methods for a user at any given time. The class libraries are included in the session file and compiled at runtime for each unique user that logs into the system.

The various webpages within the system through which the users navigate initiate the class libraries and create local instances of the object.

The system allows for easy management of many schools or other organizations. For example, the system might have 10,000 schools yet accessing and managing any one school is made easy by the use of objects. The “School” object is called once and is simply passed a unique identifier for the school that the system desires to edit. The “School” object used the unique identifier to access all the correct information in the databases or file system and only runs optimized queries in the database. The “User” object operates in a similar manner allowing for the dynamic creation of literally millions of users by simply using email addresses as the unique identifier.

The system typically also allows for the elimination of redundant information. For example, there might be 1000 parents who want the same calendar. The “User” object simply stores the school identifier for that parent and a single string with their category preferences. This storage allows a unique calendar for each parent based upon a single master calendar that the school administration has created. There is typically no need to store a complete calendar for each user. In addition, the system allows for virtually infinite combinations of schools and events while maintaining a manageable record set. This is true because parents are picking categories rather than individual events.

Many additional objects used in the system are now described.

In one implementation, the system further includes a Category Control Class Object. In general, categories and subcategories are used and manipulated in the system. The object class contains all the methods required to manipulate and query categories and subcategories. In general, the Category Control Class Object and all related objects are generally accessible by the public to manipulate and query the categories and subcategories.

A Constructor For Category Object instantiates variables required for operation of other methods related to the object. An add a new category to the database object takes data from a related array and attempts to create a new category record in the database checks database for last category identifier in order to assign the new category identifier which must be unique returns a string error or success message. An Add New Subcategory to the Database Object takes data from the array and attempts to create a new subcategory record in the database the subcategory is created with the current working category as its parent therefore no category identifier is required returns a string error or success message. A Delete A Category from the Database Object, given a category identifier, deletes this category from the database returns a string error or success message. A Delete A Subcategory from the Database Object, given a subcategory identifier, deletes this subcategory from the database returns a string error or success message. An Edit A Subcategories Object in the database updates the database record for a given subcategory with new/edited data passed in the array and returns a string error or success message. A Return Array Of Category Data Object optionally accepts an existing category identifier and returns category identifier from an array of categories. A Return Array Of Subcategory Data Object optionally accepts an existing category identifier and subcategory identifier returns an array of data for a given subcategory within the category identifier. A Create A HTML Drop-Down Selection Box Of Known Categories And Subcategories Object, generates a HTML selection box with a list of all known categories and subcategories and optionally sets an option item as selected if that options identifier is passed in selected categories. A Display A HTML Form For Inputting Category Data For Creation Or Update Object displays a HTML form allowing the user to enter data about a new category or for use in creating a new category; if the category identifier is passed, the current working category is set and that categories data is displayed for editing. A Display A HTML Form For Inputting Category Data For Creation Or Update Object displays a HTML form allowing the user to enter data about a new subcategory or for use in creating a new subcategory; if the subcategory identifier is passed, the current working subcategory is set and that subcategories data is displayed for editing. A Create HTML Table List View Of Categories With Options Object creates a table style display of categories of all current categories; the table includes links to add new subcategories and the option to delete categories (and associated category events). A Set The Current Working Category To Category Identifier loads appropriate data from database object sets the current working category to requested category (if supplied) and requests category information from the database to populate the current object with category information relevant to this category. A Set The Current Working Subcategory To Subcategory Identifier loads appropriate data from database sets the current working subcategory to requested subcategory (if supplied) and requests subcategory information from the database to populate the current object with subcategory information relevant to this subcategory.

A Clients Control Class Object contains all the methods required to manipulate and query client records stored in the database. It also supplies methods to display HTML data and forms relating to client database. A Constructor For Client Object instantiates variables required for operation of other object client methods call to set clients fills a client array at instantiation. A New Client And Client Data To The Database Object creates a new client database record from the values array, described above, which contains an associative array of data from input for the new client. A Deletes Client And Client Data From Database Object performs deletions. An Update Existing Client Data In Database Object updates existing client database record for client identifier values array contains an associative array of data collected from input for the client. A Return Verbose Client Information Object returns an array of verbose data for current working client. A Get All Clients Information Object returns an array of all client information (terse). A Display A HTML Form Element For Selecting A Client Identifier Object generates a HTML selection box with a list of all known clients and optionally sets an item as selected if that options identifier is passed in the selected array. A Display A HTML Form For Inputting Client Data For Creation Or Update Object displays a HTML form allowing the user to enter data about a new client or to edit data for the current working client; if a current working client exists, the client's data is displayed for editing. A Display A HTML Table Of Client Options Object generates a HTML table with a list of options for each known client options presented for editing and deletion of client/client data. It also displays terse client data. A Set A Client As The Current Working Client Object retrieves verbose information about client identifier from the database and stores data in a client array setting the client as the current working client. A Fill Clients Array With Client Data Object fills multidimensional clients array with arrays of terse client data retrieved from the objects above.

In another implementation, a number of objects can be defined and used to set and manipulate basic calendar date information.

An Events Object contains all the methods required to manipulate and query event records stored in the database and also supplies methods to display HTML data and forms relating to event related functionality.

A Layout Class Object is a template class that generates the table based layout website based on supplied HTML arguments. The system further includes a Constructor For Layout Object and an Events Object. A Parse Page Template Object returns a HTML table layout based on the content passed in the arguments, which essentially is a page template with flexible formatting. A Set Main Output Width Object sets HTML output width of main content section of template.

A Login Class Object provides authentication and associated services for system classes. Authentication is hierarchical in nature with all users having associated group id's which allows for the use of one user table handling several types of user, granting access to various administration levels based upon the type of user they are. Constructor For Category Objects instantiates variables required for operation of other category object methods. A Return A HTML Login Form Object presents a HTML based login form allowing the user to enter usemame and password details for authentication. A Authenticate User Submitted Usemame And Password Object validates incoming usemame and password data from the database. On successful login class, variables are set identifying the user's client identifier, user identifier and group identifier.

A Menu Class Object provides HTML menus for page formatting. Generated menu options generated differ according to the permissions of the users group identifier. A Constructor For Menu Objects sets the current working group and instantiates an array of menus via a set menu command. A Return A HTML Menu Object returns a HTML menu in table format. The menu typically only displays options available to the current working group. A Queries Database For Menu Information Object retrieves menu options from the database for current working group menu data and is stored for later use.

In another implementation, a Clients Control Class Object contains all the methods required to manipulate and query user records stored in the database. It also supplies methods to display HTML data and forms relating to the user database. A Constructor For User Object is a constructor for the user object and instantiates variables required for operation of other users object methods. It is further a call to variable fills of the user array at instantiation. An Add A New User And User Data To The Database Object creates a new user database record from the values array that contains an associative array of data from input for the new user. An Update Existing User Data In Database Object updates the existing user database record for user identification. The values array contains an associative array of data collected from input for the user. A Display A HTML Form Element For Selecting A User Identifier Object generates a HTML selection box with a list of all known user and optionally sets an item as selected if that option identification is passed in a variable. A Display A HTML Form For Inputting User Data For Creation Or Update Object displays a HTML form allowing the user to enter data about a new user or to edit data for the current working user. If a current working user exists, the user data is displayed for editing. A Display A HTML Table Of User Options Object generates a HTML table with a list of options for each known user options presented for editing and deletion of user/user data. The object also displays terse user data. A Set A User As The Current Working Client Object retrieves verbose information about user identifier from the database and stores data in a user array setting the user as the current working user. A Return Verbose User Information Object returns an array of verbose data for current working user. A Get All Users Information Object returns an array of all user information (terse). A Fill Users Array With User Data Object fills a multidimensional users array with arrays of terse user data retrieved from the database.

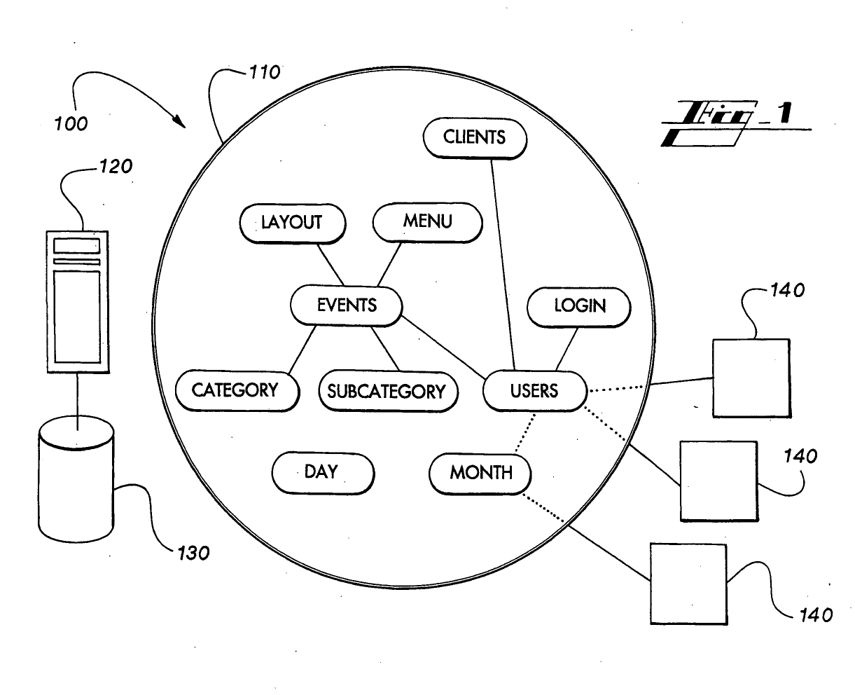

FIG. 1 illustrates a system level diagram of an embodiment of a scheduling, calendar and information distribution system 100 illustrating an implementation of the relationship of the several objects as just described as distributed in a network 110 to which the server 120 and database 130 is connected. As described above, a plurality of user computers 140 is also connected to the network.

Furthermore, in addition to the flexible and efficient nature of the system, several additional tools can be added as modules to the system. Therefore, the system provides a plug and play solution. For example, the download tool can support Microsoft Outlook as a primary module. However, as other users desire to add other modules, the redesign of the system is necessary. In a typical implementation, a new dynamic link library (.DDL) for the desired module or calendar application and a single XML file that described the manner in which the application stores the calendar events is added to the system. Likewise, similar tools can be added to export the online calendar information to a wide variety of other applications including, but not limited to Excel, Access, Word and the like.

The following figures illustrate several embodiments of webpages that can be accessed and navigated in order to log on the system, request information, add information and download information into a calendar application.

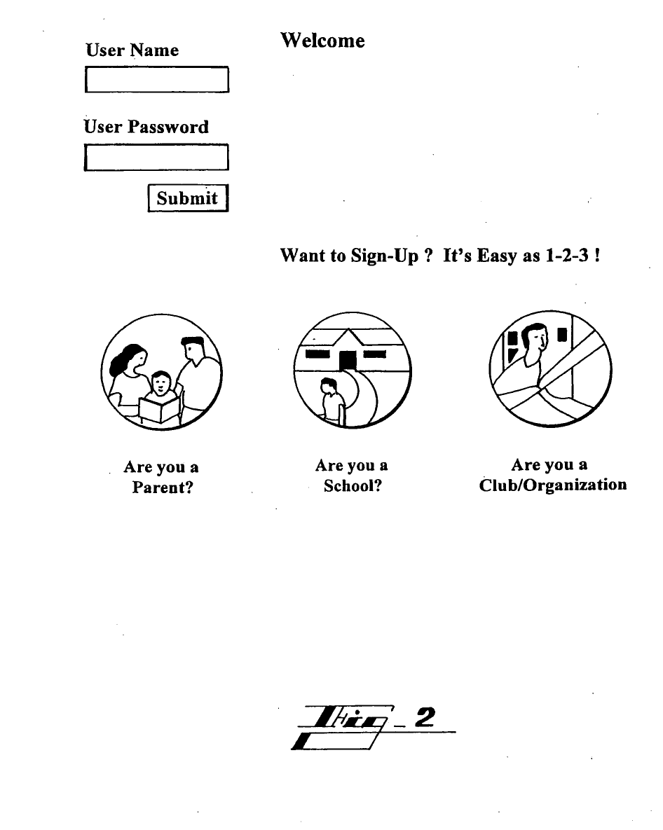

Referring to the drawings wherein like reference numerals designate corresponding parts throughout the several figures, reference is made first to FIG. 2 that illustrates an embodiment of a scheduling webpage. The scheduling webpage typically includes a name and password field for entry of the user's unique name and password. By entering the name and password, a user can thus access the system and download and modify information as needed or desired. The webpage further typically includes visual elements that can be clicked in order to access user specific areas of the webpage. In a typical embodiment, the elements can include parent, school and club/organization entry points.

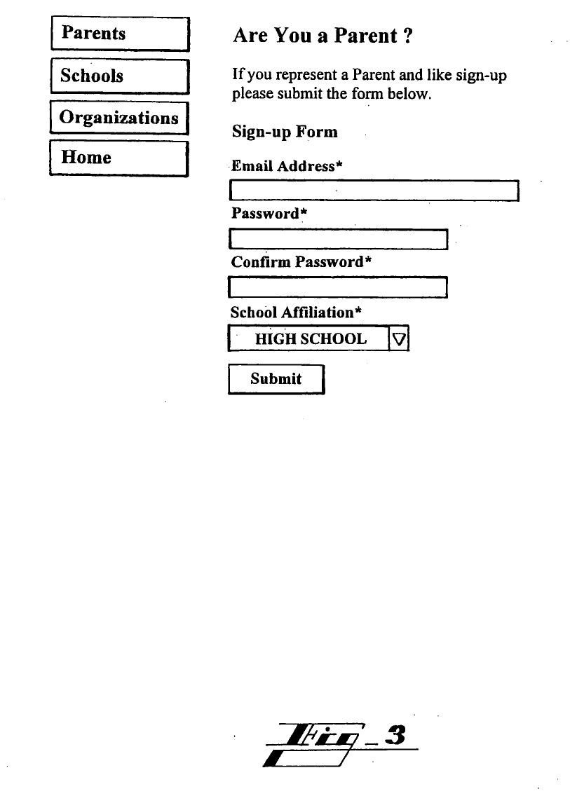

FIG. 3 illustrates an embodiment of a parent request webpage. On this webpage, a parent desiring to be part of the system in order to download, access and add information as desired, can sign up with the system. Information fields for data entry can include an email address, password and school affiliation fields.

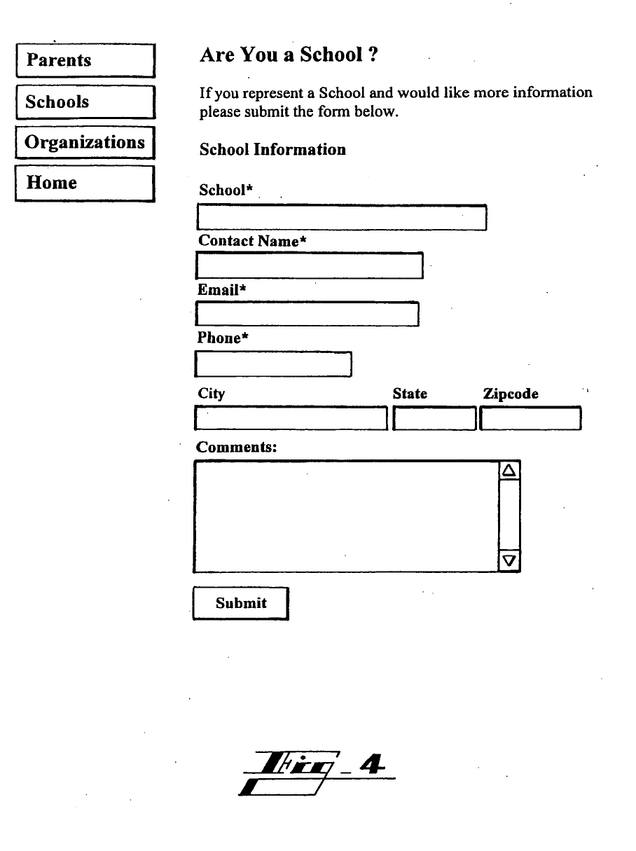

FIG. 4 illustrates an embodiment of a school request webpage. On this webpage, a school desiring to participate in the system in order to download, access and add information as desired, can sign up with the system. Information fields for data entry can include a school, contact name, email address, phone number address and other demographic information as necessary.

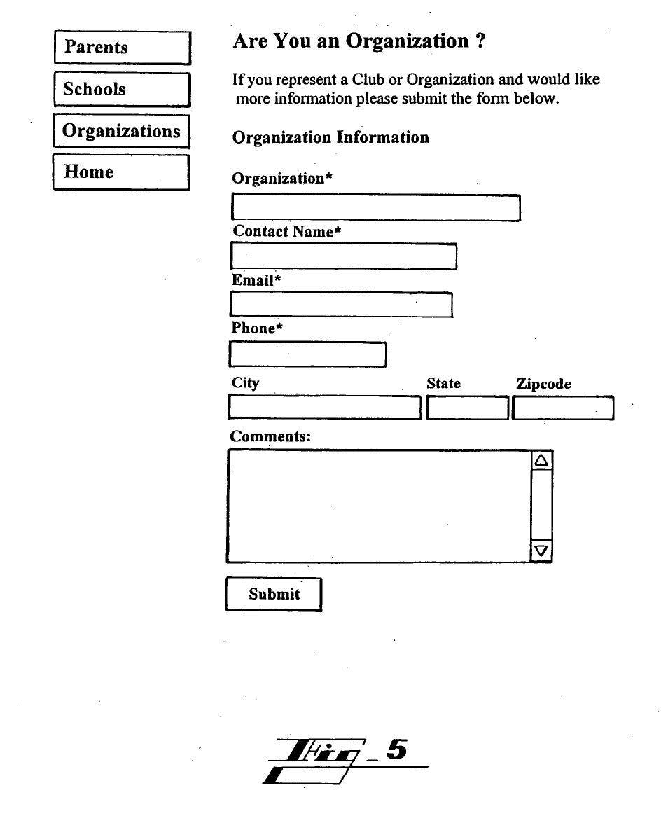

FIG. 5 illustrates an embodiment of a organization request webpage. On this webpage, an organization desiring to participate in the system in order to download, access and add information as desired, can sign up with the system. Information fields for data entry can include an organization, contact name, email address, phone number address and other demographic information as necessary.

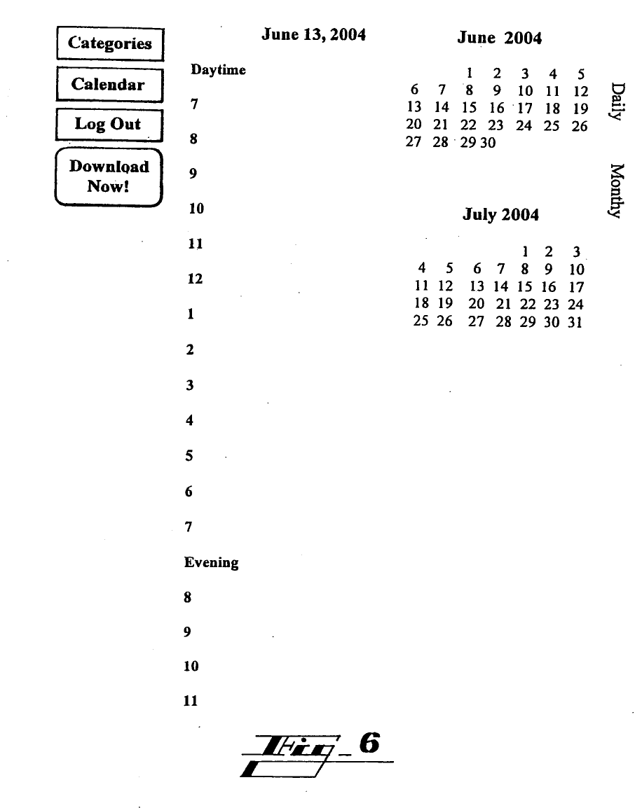

FIG. 6 illustrates an embodiment of an online calendar webpage. This webpage can be accessed from the main webpage in order to display an exemplary calendar in which a user can have a quick view to make a determination whether or not a particular day has an event scheduled. In a typical implementation, a day that includes one or more events is highlighted and in bold. A user can click a particular day to view, change or add events. Additional tabs on the screen can allow a user to switch between a daily and monthly view of the calendar and respective events.

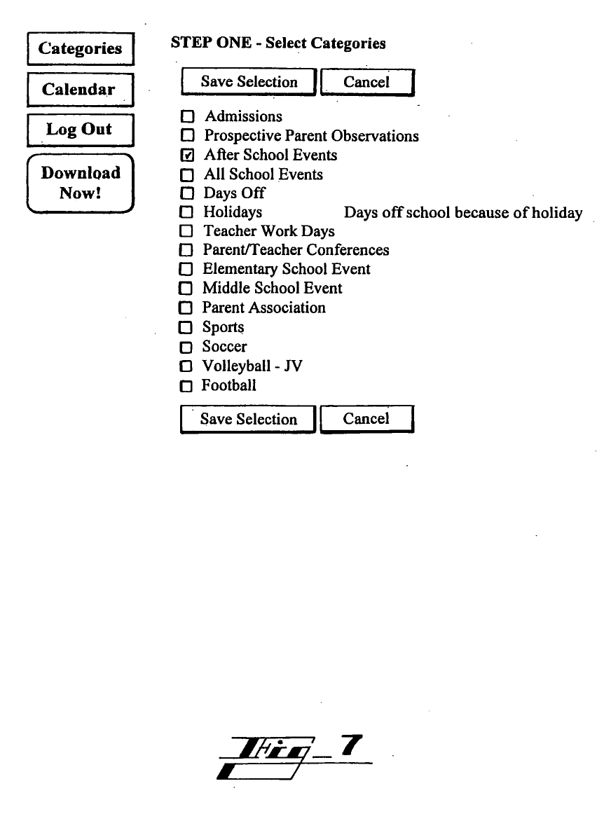

FIG. 7 illustrates an embodiment of a category selection webpage. By having clicked on the categories tab, a user can access this categories webpage. The webpage displays several categories from the database or file system. In a typical embodiment, categories can be added depending on the nature of events and the desired events to be added to the system and online calendar. By clicking next to the particular category of events, the user can pick and choose which types of events are displayed in the user's personal calendar. The user can then optionally save or cancel the selection.

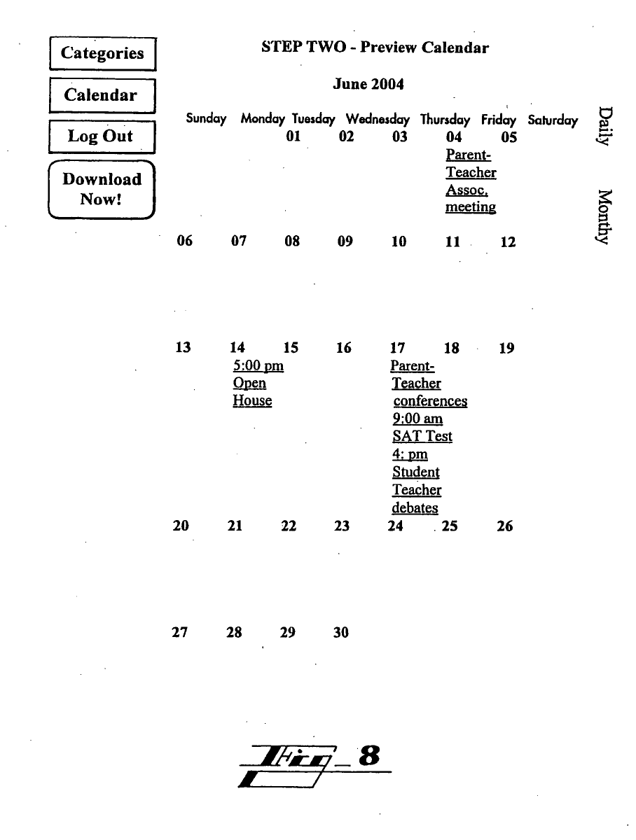

FIG. 8 illustrates an embodiment of a calendar preview webpage. The webpage represents the preview of the calendar that is downloaded to the user's personal computer and calendar. On the days that include events, a description of the particular event is included on the visual representation of the calendar. If any changes are desired to the types of events that are previewed, the user can click back to the categories page to change, update or otherwise modify the desired event categories, which in turn update the specific events on the preview calendar. In general, when the user has chosen the desired event categories and is pleased with the preview, the user can click the download tab to automatically download the events to his or her personal computer and calendar.

Therefore, in a typical implementation, the user can access the main webpage, provide a usemame and password. The user can then choose categories and click on After School Events, Days Off, and Sports (or any other desired combination of categories). In order to check the personal calendar the user can click the Calendar Tab (typically on the left side of the screen). The user can switch between the Monthly and Daily view by clicking on the tabs on the right side (typically). In Daily view, the user can click on any day of the month in the little calendar view to open another day; days with events are highlighted and bold.

By clicking download, all the calendar items that are in the system calendar are automatically downloaded to the personal calendar (such as Microsoft Outlook). All the Outlook default settings for reminders and the like are automatically applied. In this way, a user can with one simple step download all pertinent information and calendar events to his or her personal computer without any major effort or coordination.

In general, HTML has been disclosed as exemplary programming. It is understood that general programmatically displayed generated programming, or object oriented programming, is contemplated.

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in a high level procedural or object-oriented programming language, or in assembly or machine language, which can be compiled or interpreted. Suitable processors include, by way of example, both general and special purpose microprocessors. Generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

The foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A scheduling system, comprising:
a central server connected to a network;
a plurality of user computers connected to the network;
a webpage for displaying and manipulating a schedule of events stored in a database, the webpage being accessible by the central server and the plurality of user computers;
a process for adding events to the database from the central server and from the plurality of user computers;
a process for choosing a subset of selected events from the webpage to be downloaded to one or more of the plurality of user computers by a single click; and
a process residing on the central server for processing the events in the database and distributing the events over the network.

2. The system as claimed in claim 1 further comprising at least one event object that has a unique schedule of information.

3. The system as claimed in claim 2 further comprising at least one user object having unique user information.

4. The system as claimed in claim 3 further comprising at least one client object having unique client information.

5. The system as claim 1 further comprising session variables that are stored on the central server while the webpage is accessed by one or more of the user computers.

6. The system as claimed in claim 5 further comprising objects having associated class libraries.

7. The system as claimed in claim 6 further comprising a session file, comprising:
data related to the class libraries; and
data related to user objects.

8. The system as claimed in claim 7 further comprising school objects that are correlated with the user objects.

9. The system as claimed in claim 8 wherein the school object includes a school identifier and the user object includes a user identifier.

10. The system as claimed in claim 9 wherein the school identifier and user identifier are used to access and pass data related only to the school and user identifiers.

11. The system as claimed in claim 8 wherein the user and school objects are correlated by a string that identifies desired data from the school object.

12. A method of obtaining calendar information, comprising:
accessing an online webpage having an online calendar connected to a database;
choosing event categories associated with the webpage and the database;
previewing specific events included in each category; and
downloading the online calendar events to a personal calendar located on a user computer.

13. A method of organizing events, comprising:
receiving a plurality of related event information from a plurality of sources having a common relation;
organizing the event information into event categories in an online database connected to an online calendar;
making the database available to the plurality of sources;
optionally allowing the plurality of sources to modify and add to the database; and
allowing the plurality of sources to access and download the event information in a form suitable to the personal preferences of the individual source.

14. The method as claimed in claim 13 further comprising a user object and a school object.

15. The method as claimed in claim 14 wherein the user and school objects are related by identifying a subset of data from the school object into the user object.

16. The method as claimed in claim 15 wherein the plurality of sources each includes a user object.

17. The method as claimed in claim 16 wherein the plurality of sources can each access and download the event information in a form suitable to the personal preferences of the individual source and optionally modify and add to the database through the user objects.
